(19) United States
(12) Patent Application Publication
(10) Pub. No.: US 2004/0128565 A1
(43) Pub. Date: Jul. 1, 2004

(54) System for driving clock signal over a bus for a slave device

(75) Inventor: John W. Horigan, Mountain View, CA (US)

Correspondence Address: MARGER JOHNSON & McCOLLOM, P.C., 1030 S.W. Morrison Street, Portland, OR, 97205, US

(73) Assignee: Intel Corporation (a Delaware corporation), Santa Clara, CA

(21) Appl. No.: 10/334,742

(22) Filed: Dec. 31, 2002

(51) Int. Cl. G06F 1/26

(52) U.S. Cl. 713/300

(57) ABSTRACT

Embodiments of the invention include a system for driving a slave device of a serial bus when the serial bus is otherwise unused. A bus mastering device, which can be a CPU, controls a data line and a clock line of the serial bus. The bus mastering device sends a command to the slave device over the data line, and then drives the clock line of the serial bus with a clock signal. The slave device accepts the clock signal, and uses it as a clock signal to drive functions of the slave device. Existing serial bus standards may be maintained, or proprietary bus standards can be used.

### TECHNICAL FIELD

This disclosure relates to a two-line bus and, more particularly, to a system for driving a clock signal of a bus device.

### BACKGROUND

In the typical computer, a Central Processing Unit (CPU) is idle much of the time, i.e., there are relatively long periods of time in which no instructions are being performed by the CPU. The present generation of CPUs can operate at extremely high frequencies, up to 2 gigahertz and beyond. However, operating the CPU at these high frequencies during times when the CPU is idle wastes power resources and generates excess heat.

Operating frequency within a CPU is directly related to a voltage applied to the clock generating portion of the CPU, typically the core. Therefore, when an applied voltage is reduced, the operating frequency of the CPU is likewise reduced. Similarly, up to a maximum frequency of the CPU, raising the applied voltage increases the operating frequency of the CPU.

Modem CPUs must be able to modulate this frequency relatively quickly, on the order of tens of times per second, because performance suffers when the CPU has operations to perform but the operating frequency is low. Therefore, the CPU must be able to precisely and quickly control a voltage regulator that provides voltage to the CPU's core logic.

FIG. 1 illustrates a conventional system for a CPU 10 to control a voltage regulator 20. When a CPU 12 core determines the voltage should be changed, it sends a signal to a target Voltage Identification (VID) register block 14, where a particular target VID is stored. Typically, the VID is a 6-bit code, so there are a maximum of 64 discrete possible different voltage outputs that the voltage regulator 20 can provide to the CPU, although in practice this number is slightly fewer because some of the codes are reserved. A logic circuit 16 reads the updated target VID register 14, and sends a VID clock signal and an increment/decrement signal to a current VID register block 18, which sends signals to the voltage regulator 20 to change its voltage output to the current VID from the present VID.

The output from the VID register block 18 is a 6-wide parallel signal sent to the voltage regulator, one signal line for each bit in the VID. Typically, the signal is placed on six line traces placed on a printed circuit board between the CPU 10 and the voltage regulator 20.

One problem with the conventional voltage adjusting process illustrated in FIG. 1 is that it requires six pins of the CPU and voltage regulator, plus six line traces, just to adjust the CPU frequency-controlling voltage. Future CPUs need every possible pin for future enhancements, like memory controllers being built directly on the CPU. Therefore, using six CPU pins to control a voltage regulator uses too many resources.

Replacing the six line traces with bus technology would use fewer CPU pin resources. For example, a two-line bus can be used to communicate data between a CPU and a voltage regulator. The two-line bus could be an SMBus (System Management bus), first defined by Intel® Corporation in 1995, or an 12C (Inter-Integrated Circuit) Bus, developed about twenty years ago by Phillips Semiconductors, which provides an operating framework for SMBus. Both busses are well known in the industry. For instance, with reference to FIG. 2, a SMBus master 40 couples to and can communicate with many slave devices (four pictured), with only two signal lines, one for data and one for a clock. A CPU may use such a system to communicate to a slave voltage regulator device. However, speeds of these busses are generally slow, e.g., 100 kHz-1 Mhz. These slow speeds combined with the fact that each command placed on an SMBus requires 40 bits of information makes these busses unavailable to use, because it would take to long to send commands to modulate the frequency-changing voltage. Increasing the bus speed would destroy compatibility with existing SMBus and 12C devices.

Embodiments of the invention address this and other limitations of the prior art.

### BRIEF DESCRIPTION OF THE DRAWINGS

The invention will be understood more fully from the detailed description given below and from the accompanying drawings of embodiments of the invention, which, however, should not be taken to limit the invention to the specific embodiments, but are to facilitate explanation and understanding.

FIG. 1 is a block diagram illustrating a conventional voltage modulating system.

FIG. 2 is a block diagram illustrating a conventional two-line serial bus.

FIG. 3 is a block diagram illustrating a system for driving a bus slave device with a bus clock, according to embodiments of the invention.

FIG. 4 an example flow diagram illustrating processes that can be performed by embodiments of the invention.

FIG. 5 is a diagram illustrating a sample datastream that can be generated by the processes illustrated in FIG. 4.

FIG. 6 another example flow diagram illustrating processes that can be performed by embodiments of the invention.

FIGS. 7A, 7B, and 7C are diagrams illustrating a sample datastream that can be generated by the processes illustrated in FIG. 6.

FIG. 8 another example flow diagram illustrating processes that can be performed by embodiments of the invention.

FIGS. 9A, 9B, and 9C are diagrams illustrating sample datastreams that can be generated by the processes illustrated in FIG. 8.

FIGS. 10A and 10B are diagrams illustrating sample datastreams that can be generated by embodiments of the invention.

FIG. 11 is a block diagram illustrating components of a computer system that can include embodiments of the invention.

### DETAILED DESCRIPTION

Embodiments of the invention include a system for driving a slave device of a serial bus by using the bus clock. In these embodiments, a bus mastering device, which can be in a CPU itself, controls a data line and a clock line of the serial bus. The bus mastering device sends a command or series of commands to the slave device over the data line, and then drives the clock line of the serial bus with a clock signal. The slave device accepts the clock signal, and uses it as an internal clock signal to drive functions of the slave device. Driving the bus can be performed in a variety of ways. In some ways, compliance with existing serial bus standards is maintained. In other ways, the serial bus standards are not observed, in order to provide faster response from the bus slave device.

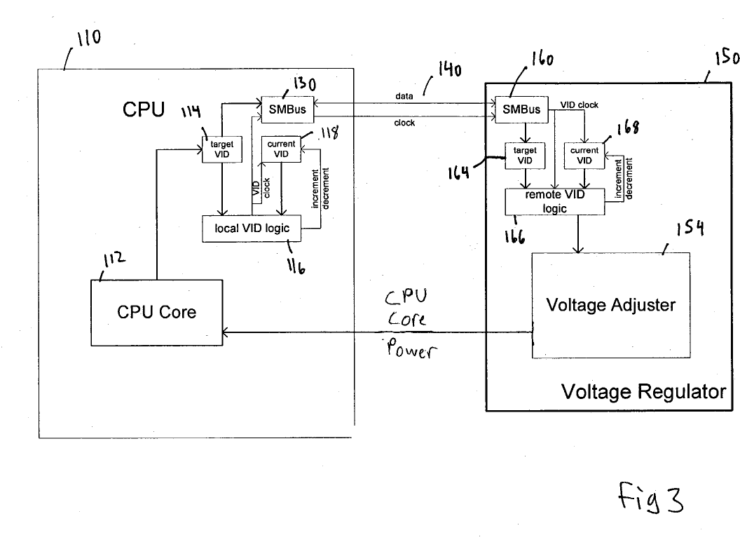

In a conventional system, for example the SMBus system shown in FIG. 2, each slave unit has an individual address. The bus-master device 40 initiates communication on the bus by sending a start signal on the data line while sending a clocking signal on the clock line. The clock signal in the conventional bus is used to coordinate bus communication. After the start signal, the bus-master 40 device sends the address of the individual slave device to which it wants to communicate. Each slave device then checks its own address with the one sent by the bus-master device 40 to determine if it is the selected device. If not, the slave device disregards any input on the data line (and on the clock line) until the bus-master 40 sends a stop signal. If the slave device is the intended recipient of the communication from the bus-master 40, the particular slave acknowledges that it is ready to communicate by sending an acknowledgement (ACK) signal. Once the communication is complete between the bus-master 40 and the selected slave device, the bus-master device sends a stop signal, and all of the slave devices coupled to the bus go to sleep and await the next start signal.

The same protocols used in the above example can be used with embodiments of the invention. However, unlike conventional slave devices, slave devices according to embodiments of the invention can operate even in absence of their own internal clock circuitry. In these embodiments, the slave devices utilize a clock signal that is propagated by the bus-master on the clock line of the bus to operate their own internal circuitry.

A block diagram of embodiments of the invention is presented in FIG. 3. In that figure, a CPU 110 includes a CPU core 112. The CPU core 112 sends a target VID signal to be stored in a target VID register 114. The target VID indicates the particular voltage that the CPU core 112 would like to receive at its voltage input. A VID logic core 116 reads the target VID signal from the VID register 114 and determines how to create the new voltage based on the current VID that is stored in a current VID register 118.

A bus-master circuit 130 is coupled to the target VID register 114. In one example, the bus-master circuit 130 is an SMBus master device. Additionally, the VID logic core 116 feeds a VID clock signal to the bus-master circuit 130. The bus-master circuit 130 creates the necessary signals to communicate over a two-line bus 140, for example an SMBus, with a voltage regulator slave device 150.

The voltage regulator 150 includes similar components to those in the CPU 110. Specifically, the voltage regulator 150 includes a slave bus unit 160 to decode signals from the bus 140. The bus slave unit 160 is coupled to a target VID register 164, a set of remote VID logic 166, and a current VID register 168. Importantly, a VID clock signal, which was created from signals on the clock line of the bus 140, is applied to the current VID register 168 and the remote VID logic 166. The remote VID logic, in turn, is coupled to a voltage adjusting circuit 154, which operates to increase or decrease a present voltage (identified by the current VID in the register 168) to the voltage identified by the target voltage VID stored in the target VID register 164. This present output voltage of the voltage regulator 150 is the voltage applied from the voltage regulator 150 to the CPU core 112.

In operation, the bus-master device 130 in the CPU 110 generates signals to communicate over the bus 140 to the voltage regulator 50 with a message to change the present voltage being applied to the CPU core 112. The slave unit 160 decodes the communication sent by the bus-master 130 and communicates to the target VID register 164, the current VID register 168 and to the remote VID logic 166 the newly received target VID. The slave bus unit 160 then continues to receive a clock signal on the clock line of the bus 140. This clock signal can represent a VID step pulse, which indicates to the voltage regulator 150 to adjust its output voltage by a set amount. The voltage regulator continues to change its output voltage by this set amount as long as it receives VID step pulses. This clock signal is further communicated to the remote VID logic 166 and to the current VID register 168, and is used by the voltage regulator 150 to change the present generated voltage from the voltage represented by the current VID to the voltage represented by the new target VID.

In this way, the voltage regulator 150, which is a slave device on the bus 140, does not need to include an internal clock circuit to perform its voltage regulating functions, because it uses the clock signal from the clock line of the bus 140.

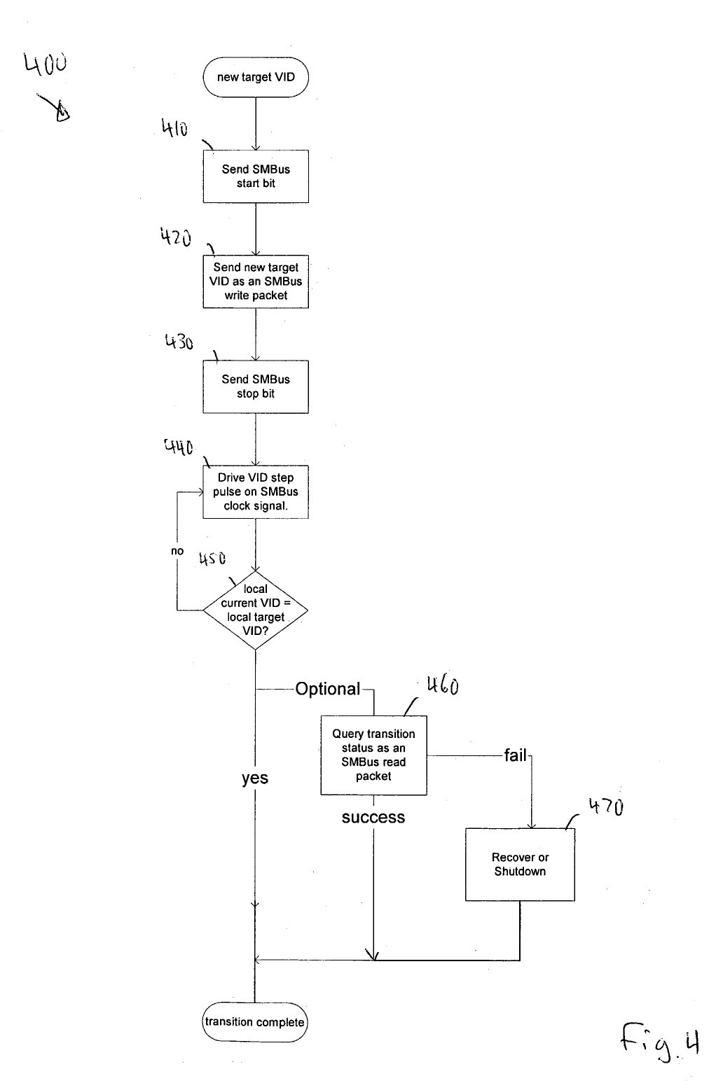

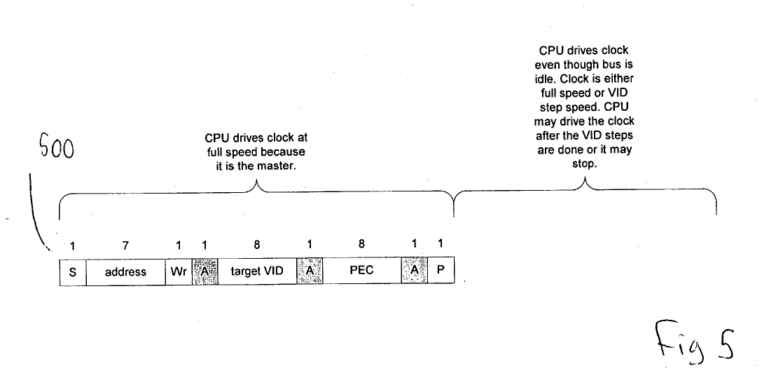

FIG. 4 is an example flow diagram illustrating processes that can be performed by embodiments of the invention. A flow 400 of FIG. 4 will be discussed with reference to FIG. 5, which illustrates a stream 500 of data (datastream) sent by the bus-master 130 of the CPU 110 over the bus 140 to the slave unit 160 in the voltage regulator 150 (FIG. 3).

The flow 400 begins when the CPU core 112 determines a new voltage is necessary to be provided to it by the voltage regulator 150. This could occur, for example, when the CPU core 112 is idling and new data and instructions are presented to the CPU 110 for operation, for which a frequency higher that the idling frequency is needed. Or, this could occur when the CPU 110 has no more instructions or data for operation, and the operating frequency of the CPU 110 is reduced to the idling frequency to save resources. In the former example, the CPU core 112 would request a target VID that represented an increased voltage to be generated by the voltage regulator 150 (which would, in turn, increase the operating voltage of the CPU 110). In the latter example, the CPU core 112 would request a target VID that causes the voltage regulator 150 to decrease its voltage.

Once it is determined that the CPU 110 desires to operate at a new frequency, the bus-master 130 sends a “start bit” onto the bus 140 in a process 410. This instructs all of the slave devices coupled to the bus 140 that a bus-master, which in this case is the CPU itself, desires to communicate with one of the slave devices on the bus 140. With reference to FIG. 5, the start bit is the first bit of the datastream 500, identified as “S”.

In addition to sending the start bit, the bus-master 130 also starts a clock pulse on the clock line of the bus 140 (not shown in FIG. 5). Initially, this clock pulse gives any slave device connected to the bus 140 the proper timing codes that enable it to receive and send data on the bus 140. In embodiments of the invention, the clock pulse is also used to drive the slave circuit itself. This is described in detail below.

Immediately after the start bit is sent, the bus-master 130 sends a 7-bit address of the desired slave device, plus a 1 bit code “Wr” that tells the slave that the bus-master wants to write data to the slave device, as opposed to read data from the slave device. In this example, the 7-bit address identifies the address of the slave device 160, which is in the voltage regulator 150. Upon recognizing that the bus-master 130 is communicating with the voltage regulator 150, the slave device 160 in the voltage regulator sends and acknowledgement, “ACK”, which appears in the datastream 500 as an “A”.

Next, in a process 420, a new target VID, which is 8 bits long, is sent on the data line of the bus 140. The 8 bits means that there could be up to 256 separate VID codes, using this embodiment of the invention. However, it is likely that some of the particular codes, or some of the bits themselves, may be used as flags, commands, or other notices. Therefore, there may, in fact, be fewer than 256 codes from which the CPU core 112 can choose. Of course, there could also be more than 256 codes by sending more than a single byte of VID code data. After the slave device 160 receives the target VID, it sends back an ACK bit. After the bus-master 130 receives this ACK from the slave device 160, a Packet Error Code (PEC) is sent to the slave device. The PEC is an error code check used to ensure that the bits in the target VID were correct. If they were correct, the slave device 160 sends yet another ACK. If the PEC had indicated that the target VID was incorrect, or incorrectly received by the slave device 160, the slave device would have sent a “NAK”, which indicates that some error condition exists.

Once the target VID has been transferred to the slave device 160, and acknowledged, the bus-master 130 sends a “Stop” bit, indicated by “P”. This is illustrated as process 430 in FIG. 4. In conventional SMBus or 12C bus implementations, when the bus-master 130 sends the stop bit, it would also stop driving a clock signal on the bus 140. However, in the embodiment described with reference to FIGS. 4 and 5, the bus-master 130 continues to drive the clock signal on the bus 140.

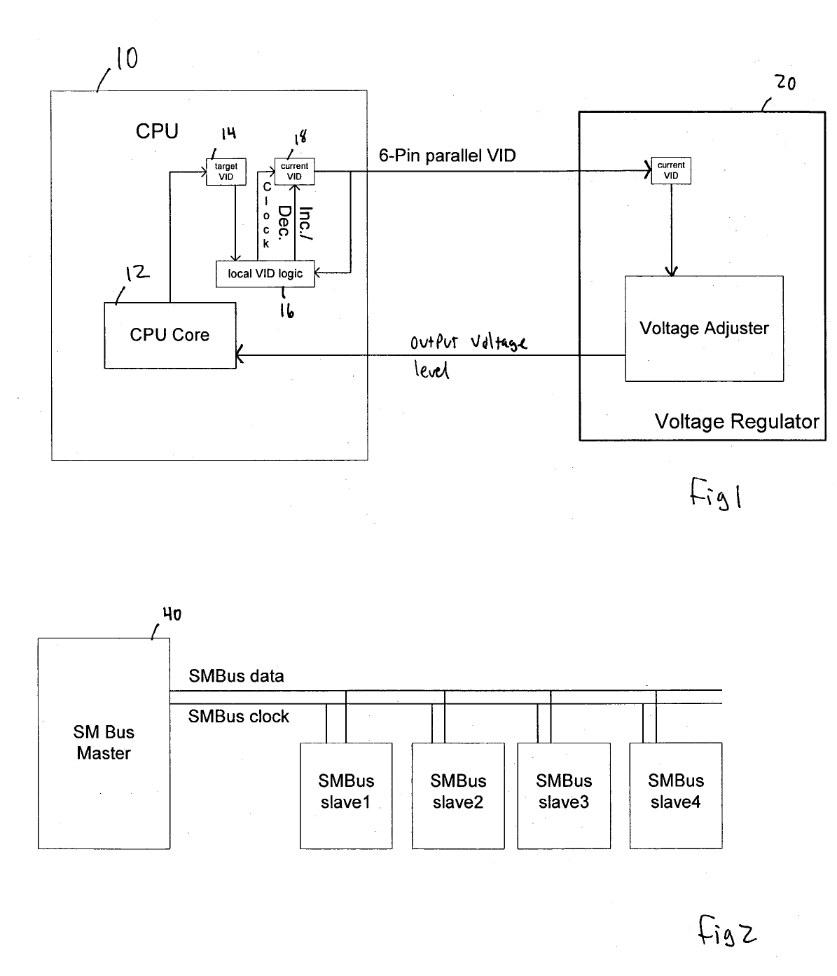

A process 440 illustrates this procedure, where the VID step pulse (a pulse that causes the voltage regulator 150 to change the voltage by a small amount in the direction of the target VID), is sent across the clock line of the bus 140. In the prior circuit illustrated in FIG. 1, for each VID step pulse, the actual output voltage from the voltage regulator 150 changes by 16 mVolts. In embodiments of the present invention, the same stepping level can be preserved, or different stepping levels could be used.

The process 440 continues to place VID step pulses (as clock signals) on the clock line of the bus 140, and a process 450 determines if the current VID (after having been changed by the VID step pulse) equals the target VID. The flow 400 remains looping through the processes 440 and 450 until the output of the voltage regulator 450 is the same as the target VID that was sent by the bus-master 130 in the process 420. During this period, the bus-master 130 can drive the clock signals at the regular full clock speed of the bus 140, or can drive the clock signals at another rate. For instance, although the typical clock speed of the bus is 1 MHz, the VID step pulses can be placed on the clock at a slower interval, such as every 5 microseconds. Or, the bus-master 130 could drive the clock line of the bus 140 at the full typical clock speed, but the voltage regulator knows to initiate a VID step pulse only every n-th clock pulse, where n determines how fast the VID step pulses are relative to the full bus clock speed.

In another embodiment, labeled optional in FIG. 4, the bus-master 130 can send a query to the slave unit 160 to determine if the voltage regulator 150 was successful in changing its voltage output to the voltage represented by the target VID. This is illustrated as a process 460 in FIG. 4. If the change was successful, then the flow 400 ends, and the voltage has been successfully changed to the voltage that the CPU core 112 desired. If, however, the voltage did not change properly, a process 470 is initiated, which institutes a recovery to establish the correct voltage, and, if no correct voltage can be established, to shutdown the CPU 110. Although the processes 460 and 470 are illustrated at the end of the flow 400, these processes can actually appear almost anywhere during the flow 400.

Once the voltage regulator 150 changes its output voltage to the one desired by the CPU core 112, the bus-master 130 can stop sending clock signals on the clock line of the bus, but it does not have to do so. It would be possible for another bus-master device coupled to the bus 140, different from the bus-master 130 in the CPU 110 to send another command to another slave coupled to the bus, even when the bus-master 130 was still driving the bus clock line. This can occur because this bus-master need only place data on the data line of the bus 140, and continue to let the bus-master 130 drive the clock line of the bus. It is preferable that only the bus-master 130 communicate with the slave device 160 of the voltage regulator 150, and not other bus-masters coupled to the bus 140, lest the voltage regulator receive conflicting commands from multiple masters.

In the embodiment above described, the communication across the bus 140 does not strictly adhere to the SMBus or 12C bus protocol. For instance, in the described embodiments, the bus-master 130 in the CPU 110 always drives the bus. In a typical solution, where having more than one bus driver is possible, whatever bus-master is currently mastering the bus drives the clock signal. Additionally, in this embodiment, the clock line continues to be pulsed even after the bus-master 130 sent out the stop bit “P.” This does not strictly adhere to the common protocols, because normally, whenever the stop bit is sent, the bus clock then stops. In the described embodiment, however, the clock signals continue to be sent to the bus clock, even after the stop bit has been sent. Finally, in some of the embodiments described above, the bus-master 130 sends a clock signal on the clock line of the bus 140 (which represent VID step signals) at a much lower rate than the normal clockspeed of the bus. To adhere to the bus standards, this is not allowed.

One reason to implement these embodiments, even though they do not comply with recognized bus standards is that the voltage can be changed with very low overhead, and in a very quick manner. Other embodiments, described below, do comply with common bus standards. As will be seen, those embodiments generally require the bus-master 130 to send much more data across the bus 140 to accomplish the same process accomplished in the already described embodiments. However, complying with existing bus protocol standards can be advantageous when the bus 140 is coupled to other bus compliant devices.

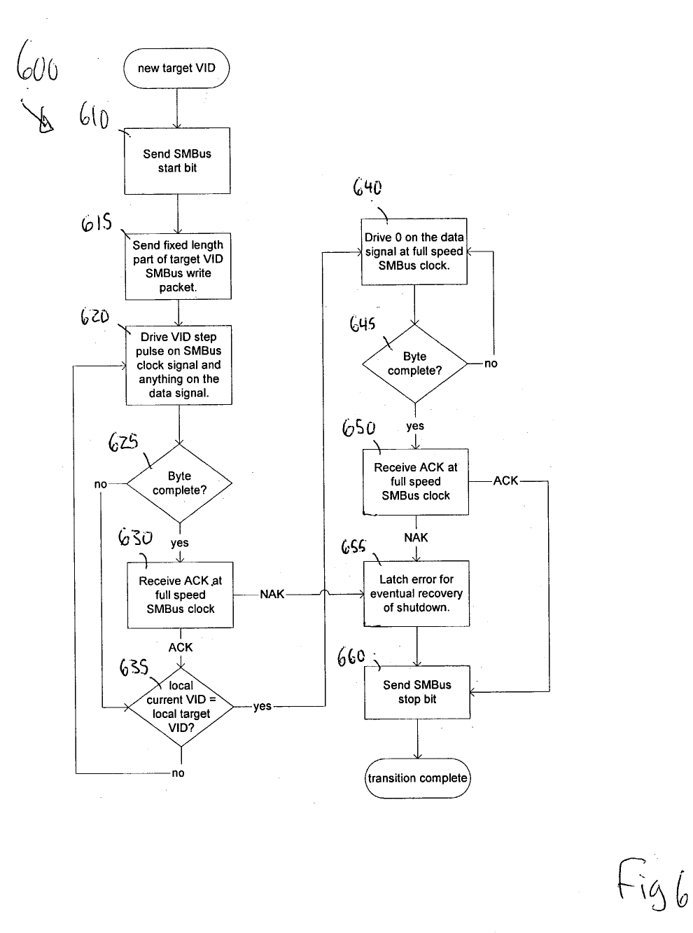

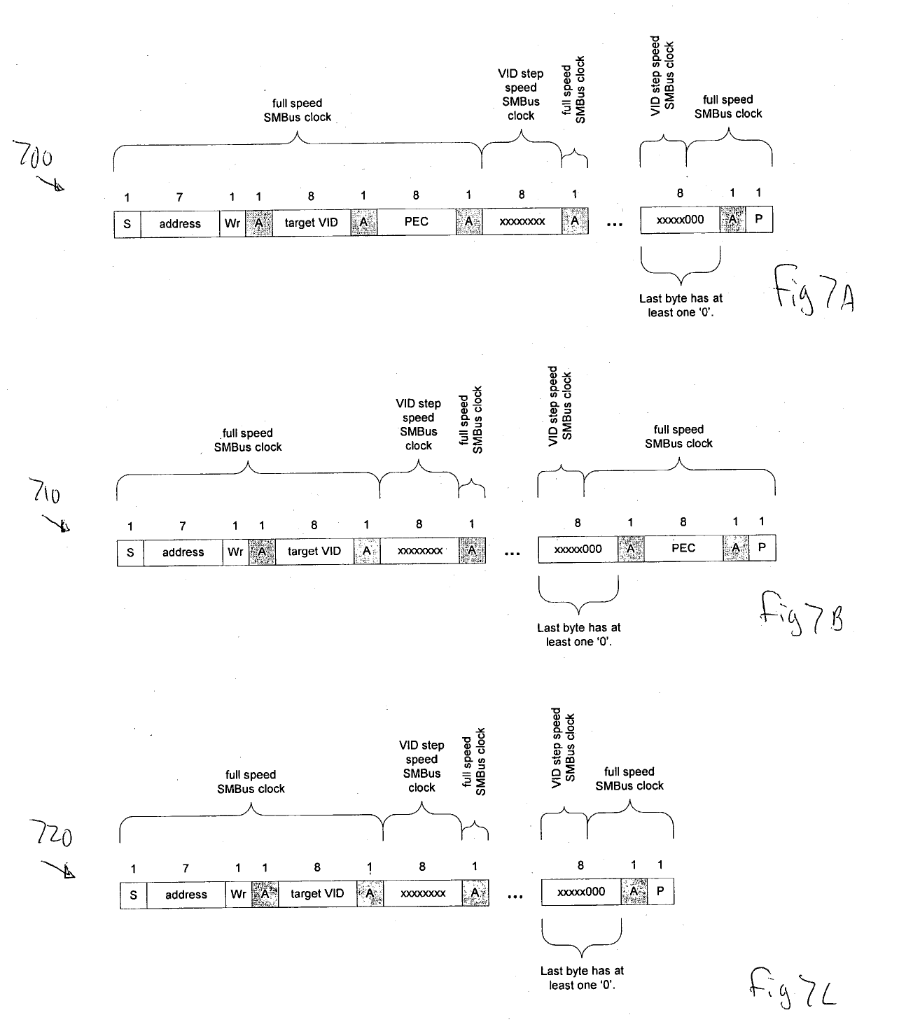

FIG. 6 is an example flow diagram illustrating processes that can be performed by embodiments of the invention that comport to the SMBus and 12C bus specifications. The processes of FIG. 6 are explained with reference to datastreams shown in FIGS. 7A, 7B, and 7C.

In general, in the embodiments described with reference to FIGS. 6 and 7, the bus-master 130 continues to send data during the entire time that it is controlling the clock on the bus clock line. In these embodiments, the bus-master 130 drives the clock at a reduced speed from the normal bus clock speed. It is still compliant, however, because the bus 140 is “owned” from the time the bus-master 130 places a start bit on the line until it places a stop bit on the line. As will be described, the bus-master 130 may change the clock frequency depending on whether it is sending VID step pulses, or standard clock pulses. Once the voltage change has been completed, the bus-master issues the stop bit, and frees the bus 140 for other bus users.

In FIG. 6, a flow 600 begins when a new target VID is issued by the CPU core 112. As with the above embodiments, and as illustrated in a datastream 700 in FIG. 7A, in a process 610 the bus-master 130 sends a start bit followed by the 7-bit address of the slave unit 160 in the voltage regulator 150, as well as the indication “Wr” that instructs that it desires to write data to the slave unit. The slave unit 160 answers with an ACK bit, illustrated in the datastream 700 as “A.”

A process 615 describes as the “fixed length portion” of the datastream 700 that the target VID and PEC are also sent by the bus-master to the slave unit 160. Each is answered with an ACK. As shown in FIG. 7A, during the processes 610 and 615, the bus-master 130 drives the clock line of the bus 140 at the full standard rate.

A process 620 begins driving the VID step pulse (as a clock signal) on the clock line of the bus 140. As indicated in FIG. 7A, this process occurs with the slow clock pulse, i.e., at the standard VID stepping time interval. During this time, the bus-master 130 places data on the data line of the bus 140, but the data can be either 1's or 0's. In other words, because the clock pulse is slowed to the VID stepping time interval, with each pulse on the clock line, the voltage regulator 150 knows to change its output voltage. Therefore, the content of the data being placed on the data line of the bus 130 in this embodiment is unimportant during this time interval.

Because the SMBus and 12C bus are byte protocol busses, a process 625 determines if the end of a byte has been reached (8 bits sent). If not, the flow 600 drops to a process 635, which determines if the output voltage of the voltage regulator 150 has reached its desired target VID. If an end of the byte has not been received, and if the target VID has not yet been reached, the flow 600 continues to loop through the processes 620, 625, and 635.

When an end of a byte has been reached, the slave unit 160 sends an ACK signal to the bus-master 130 in a process 630. This comports with the SMBus and 12C bus protocols, which state that every 8 bits of data sent by a bus-master must be acknowledged by the desired slave. As indicated in FIG. 7A, the ACK sent by the slave unit 160 can be sent at the full clock speed of the bus. In other words, there is no reason to retain the slower bus speed (at the speed of the VID stepping time interval) to receive the ACK bit.

The flow 600 continues to step through the processes 620, 625, 630, and 635 until the voltage output of the voltage regulator 150 equals the target VID. This is illustrated by the ellipsis in FIG. 7A. After the output voltage of the voltage regulator 150 equals the target VID, the flow 600 fills the rest of the current byte with zeros by looping through processes 640 and 645. These processes can be performed at full bus speed. Also, providing these processes ensures that entire bytes of data be sent from the bus-master 130 to the slave unit 160.

Once the final byte is complete, the slave unit 160 sends an ACK in a process 650, which indicates that the voltage changing process is complete, and the bus-master 130 can send a stop bit in a process 660.

If instead, there were any errors in the flow 600, either at the process 630 or at the process 650, the slave unit 160 sends a NAK bit to the bus-master 130, and a voltage recovery operation or a shutdown occurs in a process 655.

The flow 600 described above is reflected in FIGS. 7A, 7B, and 7C, with a small modification. Specifically, the location of the PEC byte differs in each datastream 700, 710, 720. To comport fully with the SMBus and 12C bus specifications, the PEC byte should be sent at the conclusion of all data sent by the bus-master 130, as illustrated in FIG. 7B. However, because, as described above, the particular VID step data sent by the bus-master 130 in these embodiments is unimportant because the voltage regulator 150 acts on the clock data alone, it is also unimportant that the PEC byte match data sent on the data line of the bus 140. The most important data sent in these embodiments is the target VID itself. Therefore, the PEC byte, to be most effective, should appear directly after the target VID data, as illustrated in FIG. 7A. Finally, given its relative unimportance, FIG. 7C does not even include a PEC byte.

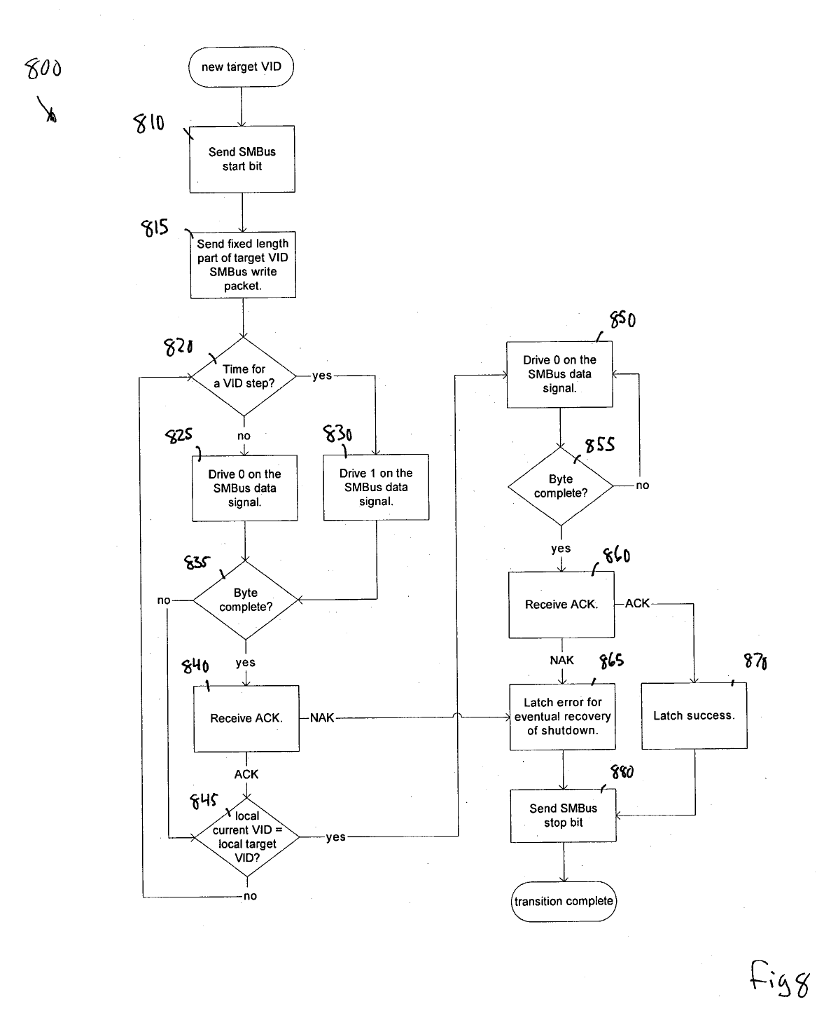

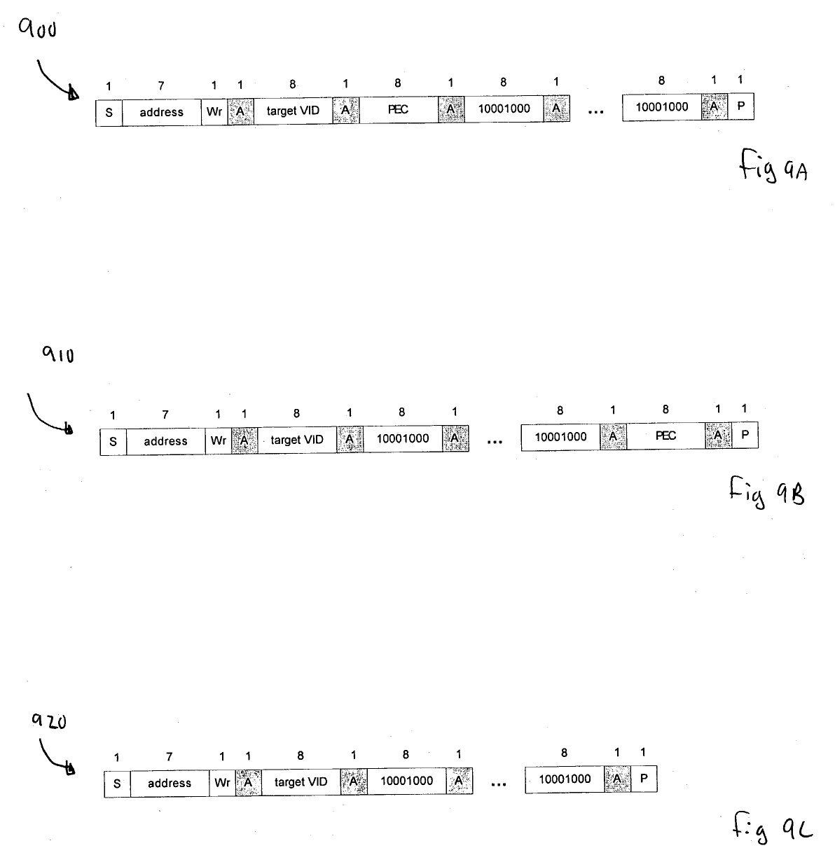

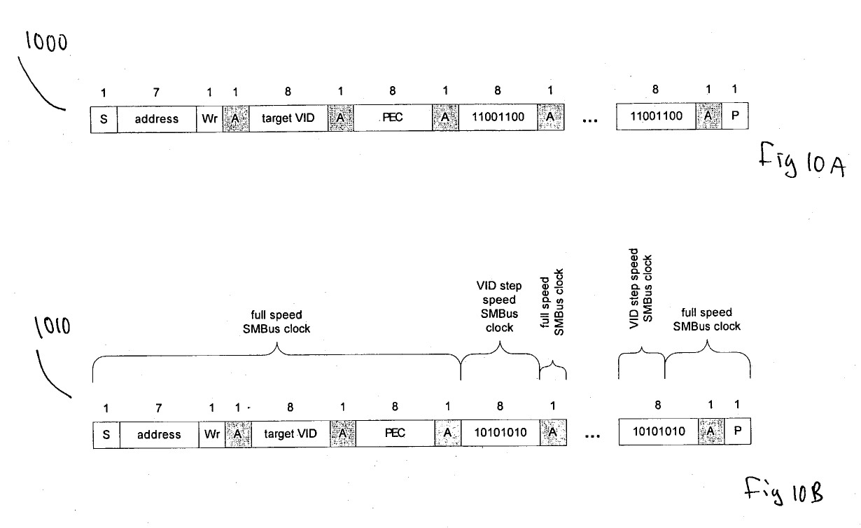

FIG. 8 is another example flow diagram illustrating processes that can be performed by embodiments of the invention that comport to the SMBus and 12C bus specifications. The processes of FIG. 8 are explained with reference to datastreams shown in FIGS. 9A, 9B, and 9C.

The embodiments illustrated in FIGS. 8, 9A, 9B, and 9C are similar to the embodiments discussed with regard to FIGS. 6, 7A, 7B, and 7C. For the sake of brevity, steps that are very similar to those that have already described will not be again described.

In general, the flow diagram of FIG. 8 illustrates communication from the bus-master 130 to the slave unit 160 where the clock signal on the clock line of the bus 140 is always driven at full clock speed. Because, in some embodiments this would create VID step pulses too quickly, only particular clock pulses trigger VID step pulses in the voltage regulator 150. Specifically, the bus-master 130 will put a “1” (or some other pre-determined symbol) on the data line of the bus 140 when the voltage regulator 150 is to use the next clock pulse as a VID step pulse. Otherwise, when the bus-master puts a “0” on the data line of the bus 140, the voltage regulator 150 does nothing, even though clock pulses are received.

As in the preceding embodiments, the flow 800 begins when the CPU core 112 desires to change the core operating frequency, which is directly related to the output voltage from the voltage regulator 150. In processes 810 and 815, the bus-master 130 sends the start bit, address of the slave unit 160, read/write bit, target VID and PEC byte, as illustrated in the datastreams 900, 910 and 920 of FIG. 9. Similar to FIG. 7, the datastreams 900, 910, and 920 differ only in their placement of the PEC byte, and are otherwise identical.

In a process 820, the flow 800 determines if it is time for a VID step pulse. Unlike some of the earlier embodiments, in the flow 800, the rate at which the clock line on the bus 140 is driven (the bus clock speed) is faster than the VID step pulse. Therefore, there are some clock pulses that do not cause a VID step pulse to be performed by the voltage regulator 150. Because this is the first iteration of the flow 800, it will be time for a VID step pulse in the process 820, and the flow 800 exits the process 820 in the YES direction. In a process 830, the bus-master 130 places a “1” on the data line of the bus 140, which indicates to the voltage regulator that the next clock pulse should also be a VID step pulse. This is seen in the datastream 900 of FIG. 9, where the fourth byte begins with a “1”. In the datastreams 910 and 920, this corresponds to the third byte.

If the last bit written to the data line of the bus 140 is on a byte boundary, the slave unit 160 sends an ACK to the bus-master 130. If, however, a byte boundary has not yet been reached, the flow 800 exits a process 835 in the NO direction. If the output voltage of the voltage regulator does not yet equal the target VID, in a process 845, the flow 800 loops back to the process 820.

If it is not yet time for a VID step pulse, the flow 800 exits the process 820 in the NO direction, and a “0” is written to the data line of the bus 140. This is also illustrated in the datastream 900 of FIG. 9A.

Once a process 845 determines that the output voltage of the voltage regulator 150 equals the target VID, then the flow 800 begins to shut down communication to the slave unit 160. In processes 850 and 855, the bus-master fills out the last remaining byte on the data line of the bus 140 with zeros. As in the previous examples, in a process 860 the bus-master can query the slave unit 160 to be sure that all of the instructions have been received correctly. If so, the bus-master 130 knows that the voltage change was successful. If not all of the instructions have been properly received, the CPU 110 can try to recover, or shutdown, in a process 865. Finally, after all of the voltage changing data has been sent to the voltage regulator 150, the bus-master 130 sends a stop bit in a process 880.

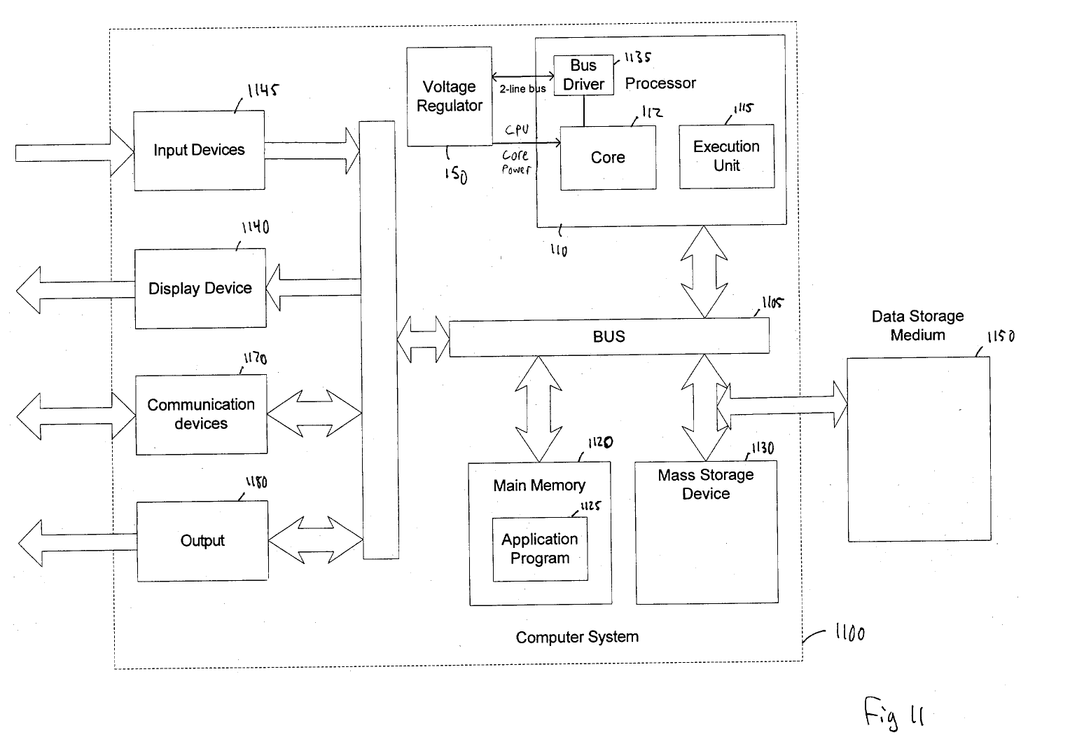

FIGS. 10A and 10B illustrate datastreams 1000 and 1010, which can be generated by still other embodiments of the invention. The datastreams 1000 and 1010 differ from those of the datastreams 900 of FIG. 9A and 700 of FIG. 7A, respectively, beginning at the fourth byte. Generally, the embodiments shown in FIGS. 10A and 10B use an error-checking dataflow between the bus-master 130 and slave unit 160. Specifically, in the datastream 1000, the clock speed of the bus runs at full speed and the signal that indicates that a VID step pulse should occur in the voltage regulator 150 is a pair of back-to-back “1's”. By having the signal to the voltage regulator 150 include two separate data transfers, in this case two “1s”, the slave unit 160 can actively check for error conditions. In other words, if the slave unit 160 ever receives a single “1” bit or more than two back-to-back “1” bits on the data line of the bus 140, the slave unit determines that an error has occurred, and notifies the CPU 110. The data portions of the datastream 1010 of FIG. 10B are generated at the slower bus clock speed, as indicated in that figure. In this embodiment, the voltage regulator 150 performs a VID step pulse each time a data bit is received, be it a “0” or a “1”. But if the slave unit 160 ever receives two back-to-back 1s or 0s, the slave unit determines that an error has occurred, and notifies the CPU 110.

Errors in the dataflow can cause VID steps to occur too fast, compromising functionality in CPU core 112. When an error-checking dataflow is used, the slave unit 160 is able to detect many types of errors immediately when they occur, so that erroneous VID steps can be avoided. Early error detection allows for more graceful error recovery. Without an error-checking dataflow, errors are only discovered at the end of the transition and the only reliable response is to shutdown CPU core 112.

Embodiments of the invention can operate in computer environments. A computer system 1100 in which embodiments of the invention can operate is illustrated in FIG. 11. The computer system 1100 can have similar or different components without departing from the scope of the invention. In general, the computer system 1100 includes a main bus 1105 for communicating information, and a processor 110 including an execution unit 1115 coupled to the main bus 1105 for processing information. The processor 110 can be one of the processors described above with reference to FIGS. 3-10. A main memory 1120 coupled to the main bus 1105 for storing information and instructions for the processor. For example, the main memory 1120 may store an application program 1125 which may be transferred to the main memory 1120 from another memory, such as a mass storage device 1130 also coupled to the main bus 1105. The computer system 1100 also includes a display device 1140 coupled to the main bus 11 05 for displaying information to the computer system user, and an input device or devices 1145 coupled to the main bus 105 for communicating information and command selections to the processor 110. Also coupled to the main bus 1105 are one or more communication devices 1170, such as a network interface card, and output devices 1180, such as a printer.

The mass storage device 1130 is coupled to the main bus 1105 for storing information and instructions for use by the processor 110. A data storage medium 1150 containing digital information is configured to operate with the mass storage device 1130 to allow the processor 110 access to the digital information on the data storage medium 1150 via the main bus 1105. The mass storage device 1130 may be a conventional hard disk drive, floppy disk drive, compact disc read only memory (CD ROM) drive, digital versatile disk (DVD) drive, chip reader, or other magnetic or optical data storage device for reading and writing information stored on the data storage medium 1150, which may be a hard disk, a floppy disk, a CD ROM, DVD, a magnetic tape, an EEPROM or some other ROM device, or other magnetic or optical data storage medium. The data storage medium 1150 is capable of storing sequences of instructions that cause the computer system 1100 to perform specific functions, which could include a system for driving a clock line of a two-line bus.

The processor 110 is coupled to the voltage regulator 150 through a two-line communication bus, as described above. The processor 110 and voltage regulator 150 can be embodied by those described above with reference to FIGS. 3-10, for example. The bus-master 130, as described above, can be a portion of a bus driver 1135 included within the processor 110 as illustrated in FIG. 11.

In operation, as the processor 110 operates on programs in the execution unit 1115, it may desire to change the frequency at which it is operating. To change the frequency, the core 112 indicates to the bus driver 1135 that the voltage from the voltage regulator 150 should be adjusted. The bus driver 1135 communicates with the voltage regulator 150 as described above, to effectuate the voltage change.

Embodiments of the invention provide many advantages. One benefit provided is a reduction of resources (CPU pins, traces, etc.) used to adjust a voltage provided to the CPU core 112. Another benefit is that the bus driver 1135 can be used to communicate with other devices with the computer system 1100. Another advantage to the invention is that it can be embodied in many different ways, operate on a number of different types of busses, both compliant with present bus standards or not, and is not tied to any one specific hardware or software scheme.

Those skilled in the art recognize that the system for driving a clock signal over a bus for use by a clockless slave device can be implemented in many different variations, in software, hardware or firmware in almost any combination. Therefore, although various embodiments are specifically illustrated and described herein, it will be appreciated that modifications and variations of the present invention are covered by the above teachings and within the purview of the appending claims without departing from the spirit and intended scope of the invention.

What is claimed is:

1. A method for driving a slave device coupled to a serial bus, the method comprising:
sending serial data to the slave;
driving the slave with a clock signal during the sending; and
after the sending of the serial data, continuing to drive the slave with the clock signal.

2. The method according to claim 1 wherein continuing to drive the slave with the clock signal comprises clocking the slave with the clock signal.

3. The method according to claim 1 wherein sending serial data to the slave comprises sending serial data to the slave in a manner consistent with SMBus protocol.

4. The method according to claim 1 wherein sending serial data to the slave comprises sending serial data to the slave in a manner consistent with 12C bus protocol.

5. The method according to claim 1, further comprising
fixing the potential of a data line of the bus while continuing to drive the slave with the clock signal after the sending.

6. The method according to claim 1 wherein sending serial data to the slave comprises sending a target voltage value to a voltage regulator.

7. The method according to claim 6 wherein driving the slave with a clock signal comprises sending a signal to the voltage regulator to adjust a present voltage of the voltage regulator toward the target value at a particular rate of change.

8. The method according to claim 7 wherein sending a signal to the voltage regulator to adjust a present voltage of the voltage regulator comprises sending a clock signal only.

9. The method according to claim 7 wherein sending a signal to the voltage regulator to adjust a present voltage of the voltage regulator comprises sending a clock signal on a clock line and a data signal on a data line.

10. The method of claim 1, further comprising:
using a first frequency of a clock signal while sending serial data to the slave; and using a second frequency of the clock signal while driving the slave with the clock signal.

11. A method for operating a computer system, comprising:
receiving, at a core of a central processing unit, a first voltage value from a power supply;
determining to change the first voltage value to a second voltage value;
sending a signal to the power supply over a two-line bus indicating a voltage change request; and
receiving a second voltage value at the processing unit core from the power supply.

12. The method of claim 1 1, further comprising changing an output voltage from the power supply from the second voltage to the first voltage at a controlled rate of change.

13. The method of claim 11 wherein determining to change the first voltage value to a second value is performed within the processing unit core.

14. The method of claim 11 wherein sending a signal to the power supply over a two-line bus indicating a voltage change request comprises:
generating a signal indicating a voltage change request;
sending serial data to a voltage regulator;
driving the voltage regulator with a clock signal during the sending; and
after the sending of the serial data, continuing to drive the voltage regulator with the clock signal to control a rate of voltage transition in the voltage regulator.

15. The method according to claim 14 wherein sending serial data to the voltage regulator comprises sending serial data to the voltage regulator in a manner consistent with SMBus protocol.

16. The method according to claim 14 wherein sending serial data to the voltage regulator comprises sending an indication of the second voltage value to the voltage regulator.

17. The method according to claim 14 wherein continuing to drive the voltage regulator with the clock signal comprises sending a clock signal only.

18. The method according to claim 14 wherein continuing to drive the voltage regulator with the clock signal comprises sending a clock signal on a clock line of the two-line bus and sending a data signal on a data line of the two-line bus.

19. A computer system, comprising:
a central processor including a core unit;
a bus driving circuit coupled to the core unit
a two-line bus coupled to the bus driving circuit; and
a voltage regulator coupled to the two-line bus and structured to generate a voltage signal for the core unit.

20. The computer system of claim 19, wherein the two-line bus uses SMBus protocol.

21. The computer system of claim 19 wherein the bus driving circuit is structured to generate a clock signal on a clock line of the two-line bus.

22. The computer system of claim 21 wherein the voltage regulator is structured to receive the clock signal and perform functions based on the clock signal. received.

23. The computer system of claim 21 wherein the voltage regulator is structured to receive the clock signal and a data signal over the two-line bus, and wherein the voltage regulator is structured to perform functions based on the received clock signal and data signal.

24. The computer system of claim 19 wherein the voltage regulator contains no internal clock for regulating a change in an output voltage.

25. A central processing unit, comprising:
a core unit structured to receive an input voltage and structured to generate a voltage change signal; and
a bus-driving circuit structured to receive the voltage change signal and to generate signals on serial bus indicative of the voltage change signal.

26. The central processing unit of claim 25 wherein the serial bus is a two-line bus.

27. The central processing unit of claim 25 wherein the serial bus communicates using an SMBus protocol.

28. The central processing unit of claim 25 wherein the bus-driving circuit comprises:
a clock-line driving circuit structured to generate a clock signal on the serial bus; and
a data-line driving circuit.

29. A programmable voltage regulator, comprising:
a serial bus receiver structured to receive a clock signal from a serial bus; and
a voltage adjusting circuit structured to change an output voltage of the voltage regulator based on the clock signal received.

30. The voltage regulator of claim 29, wherein the receiver is also structured to receive a data signal from the serial bus, and wherein the voltage adjusting circuit is structured to change the output voltage based on the clock signal received and the data signal received.

31. The voltage regulator of claim 29 wherein the serial bus receiver is structured to receive SMBus protocol data from the serial bus.
